(19) United States
(12) Patent Application Publication
(10) Pub. No.: US 2015/0149531 A1
(43) Pub. Date: May 28, 2015

(54) Dynamically Selected Message Refresh Interval

(71) Applicant: AT&T Intellectual Property I, L.P., Atlanta, GA (US)

(72) Inventors: Randolph Wohlert, Austin, TX (US); Karen Mullis, Loganville, GA (US)

(73) Assignee: AT&T Intellectual Property I, L.P., Atlanta, GA (US)

(21) Appl. No.: 14/091,959

(22) Filed: Nov. 27, 2013

(51) Int. Cl. H04L 29/06

(52) U.S. Cl. CPC H04L 65/1003
USPC 709/203

(57) ABSTRACT

A system and method includes transmitting, from a client device, a message to a server via a network (including a core network, an access network, other additional networks or network elements). The method further includes determining a characteristic associated with the network. The method also includes determining, at the client device, a session refresh period based on the determined characteristic associated with the network. The method also includes transmitting, from the client device, a refresh message to the server upon expiration of the session refresh period.

### FIELD OF THE DISCLOSURE

The present disclosure is generally related to dynamically selecting a message refresh interval.

### BACKGROUND

A Subscribe/Publish/Notify model may be used to share up-to-date information between a client device and a server. For example, in session initiation protocol (SIP), a Subscribe/Publish/Notify model may be used to exchange social presence information and/or user device capability. A Subscribe message and/or a Publish message may be associated with a SIP session timer that limits the amount of time during which the Subscribe message and/or the Publish message is valid. After the Subscribe message and/or the Publish message is transmitted from a client device to a server, a refresh message (e.g., a copy of the Subscribe message and/or the Publish message) is transmitted from the client device to the server prior to the expiration of the SIP session timer to keep the Subscribe message and/or the Publish message from becoming stale (e.g., inactive).

The refresh message is transmitted when the SIP session timer reaches a fixed threshold percentage (e.g., 80%). The available bandwidth for control plane signaling in communication networks is limited. Early transmission of refresh messages increases control plane traffic congestion and may degrade a user experience associated with a service provider. For example, when the SIP session timer has a large value (e.g., 4500 seconds) the refresh message may be transmitted too early (e.g., 900 seconds before the SIP timer expires) leading to increased control plane traffic congestion. Conversely, when the SIP session timer has a small value (e.g., 10 seconds) the refresh message may be transmitted too late (e.g., 2 seconds before the SIP timer expires). In which case the refresh message may not reach the server before the expiration of the timer.

### BRIEF DESCRIPTION OF THE DRAWINGS

FIG. 1 is a block diagram of an illustrative embodiment of a system for dynamically selecting a session refresh interval;

FIG. 2 is a block diagram of an illustrative embodiment of a system for dynamically selecting a session refresh interval after a triggering event;

FIG. 3 is a series of timing charts illustrating a first embodiment of dynamically selecting a session refresh interval;

FIG. 4 is a series of timing charts illustrating a second embodiment of dynamically selecting a session refresh interval;

FIG. 5 is a timing chart illustrating a third embodiment of dynamically selecting a session refresh interval;

FIG. 6 is a flowchart of an illustrative embodiment of a method of dynamically selecting a session refresh interval;

FIG. 7 is a flowchart of an illustrative embodiment of a method of dynamically selecting a session refresh interval after a triggering event; and

FIG. 8 is a block diagram of an illustrative embodiment of a computer system operable to support the various methods, systems, and computer-readable storage devices disclosed with respect to FIGS. 1-7.

### DETAILED DESCRIPTION

Systems and methods of dynamically selecting a message refresh interval are disclosed. A client device may dynamically select a session refresh period based on characteristics associated with a network coupled to the client device. The characteristics may be indicative of data transfer rates associated with the network. The characteristics may include a type of the network (e.g., broadband, LTE, 3G, etc.). The characteristics may also, or in the alternative, include a measured response time of the network. The characteristics may also, or in the alternative, include a quality of service (QoS) setting of the network. Based on the characteristics, the client device may dynamically select relatively longer refresh periods for faster networks and relatively shorter refresh periods for slower networks.

In an embodiment, a method includes transmitting, from a client device, a message to a server via a network. The method also includes determining a characteristic associated with the network. The method further includes determining, at the client device, a session refresh period, wherein a duration of the session refresh period is determined based on the determined characteristic associated with the network. The method also includes transmitting, from the client device, a refresh message to the server upon expiration of the session refresh period.

In another embodiment, an apparatus includes a processor and a memory. The memory stores instructions that, when executed by the processor, cause the processor to perform operations. The operations include receiving an indication of a session expiration period from a server via a network. The operations also include determining a session refresh period based on a characteristic of the network and based on the session expiration period. The operations further include determining a session refresh period based on the characteristic of the network. The operations also include transmitting a refresh message to the server upon expiration of the session refresh period.

In another embodiment, a computer-readable storage device stores instructions that, when executed by a processor, cause the processor to perform operations. The operations include transmitting a message to a server via a network. The operations also include receiving an indication of a session expiration period from the server. The operations further include determining a session refresh period based on a characteristic of the network and based on the session expiration period. The operations also include transmitting, from the client device, a refresh message to the server upon expiration of the session refresh period.

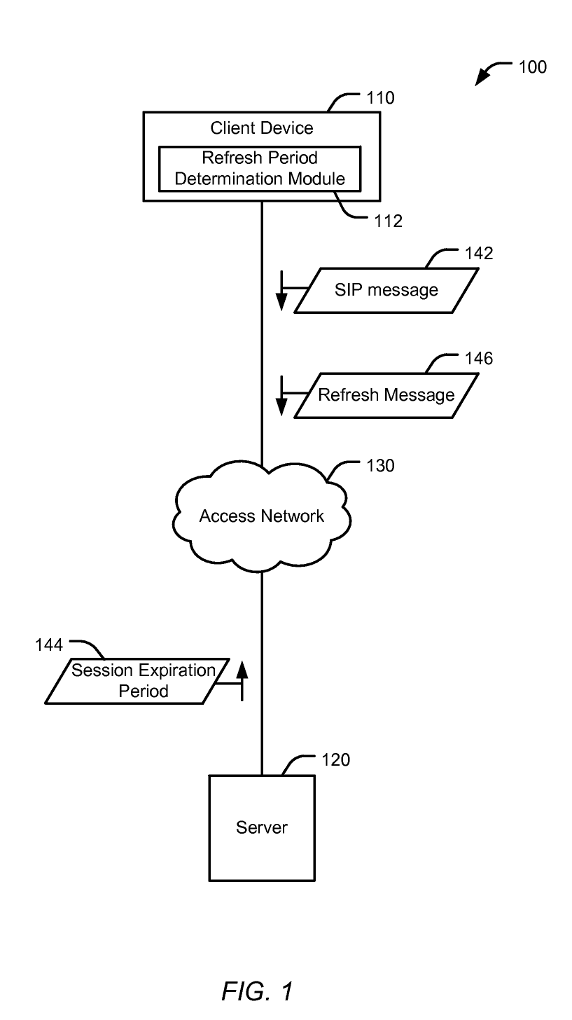

Referring to FIG. 1, a system 100 for dynamically selecting a session refresh interval includes a client device 110 (e.g., a personal computer (PC), a tablet, a set-top box (STB), a personal digital assistant (PDA), a mobile device, a palmtop computer, a laptop computer, a desktop computer, a communications device, a wireless telephone, etc.). The system 100 further includes a server 120 coupled to the client device 110 via a network 130. The network 130 may include any number of network components along a data path between the client device 110 and the server 120. For example, the network 130 may include any number of access networks, core networks, switches, other computing devices, or any combination thereof.

The client device 110 may include a refresh period determination module 112. The refresh period determination module 112 enables the client device 110 to dynamically select a session refresh period based on one or more characteristics of the network 130. By dynamically selecting a session refresh period, the client device 110 may decrease traffic over the network 130 by preventing refresh messages from being sent long before expiration of a communication session between the client device 110 and the server 120. Thus, users of the network 130 may have a better user experience due to reduced network congestion.

In operation, the client device 110 may send a message 142 (e.g., a session initiation protocol (SIP) message, a hypertext transmission protocol (HTTP) message, etc.) to the server 120 via the network 130. For example, the client device 110 may communicate with the server 120 using a Subscribe/Publish/Notify model. The message 142 may include a Subscribe message and/or a Publish message. In response to the message 142, the server 120 may send an indication of a session expiration period 144 to the client device 110. For example, the server 120 may send an acknowledgment message to the client device 110, where the acknowledgment corresponds to the message 142 and includes the indication of the session expiration period 144. Alternatively, the server 120 may send the indication of the session expiration period 144 at a time the client device 110 registers (or initializes) on the network (before the message 142 is sent). After the message 142 is sent and upon receiving subsequent messages, the server 120 may send updated indications of the expiration period.

The refresh period determination module 112 may be configured to determine characteristics of the network 130. For example, the refresh period determination module 112 may determine a type of the network 130 and the session refresh period may be determined based on the type of the network 130. The refresh period determination module 112 may query a network device (e.g., a wireless access point, a residential gateway, a network database, etc.) associated with the network 130 to determine the type of the network 130. To illustrate, the refresh period determination module 112 may receive input from the network device indicating that the network 130 is a broadband network, a long term evolution (LTE) network, a third generation (3G) network, or another type of network. Alternatively, the client device 110 may retain information (e.g., within a memory of the client device 110) identifying the type of the network. The retained information may be provided to the refresh period determination module 112 to determine the type of the network 130.

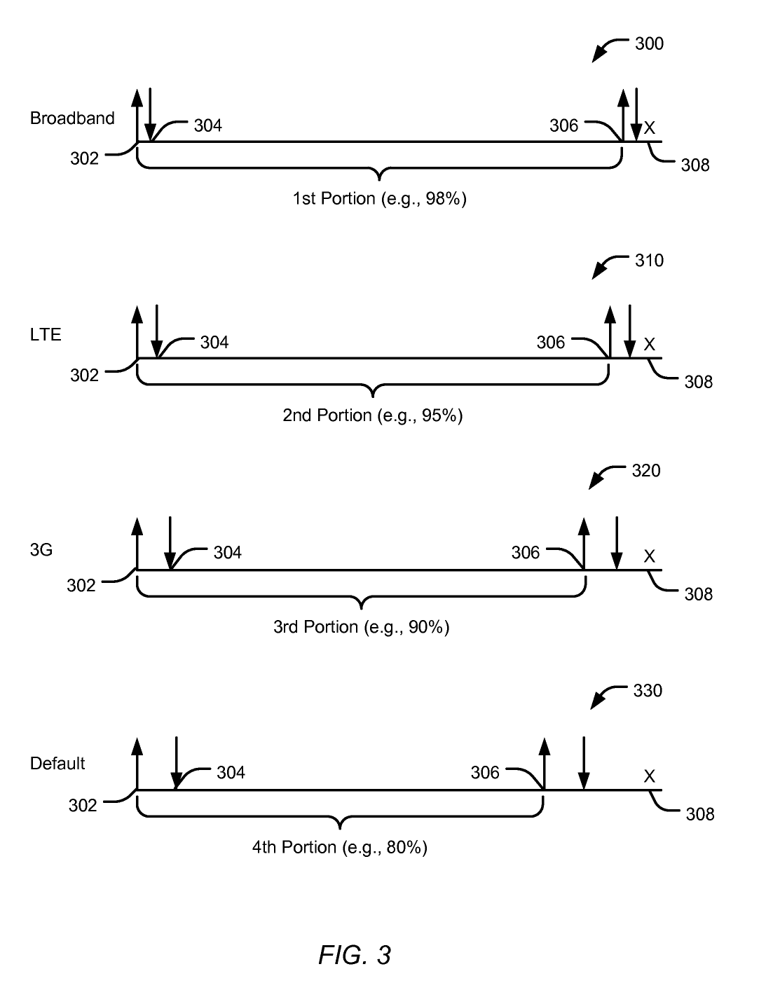

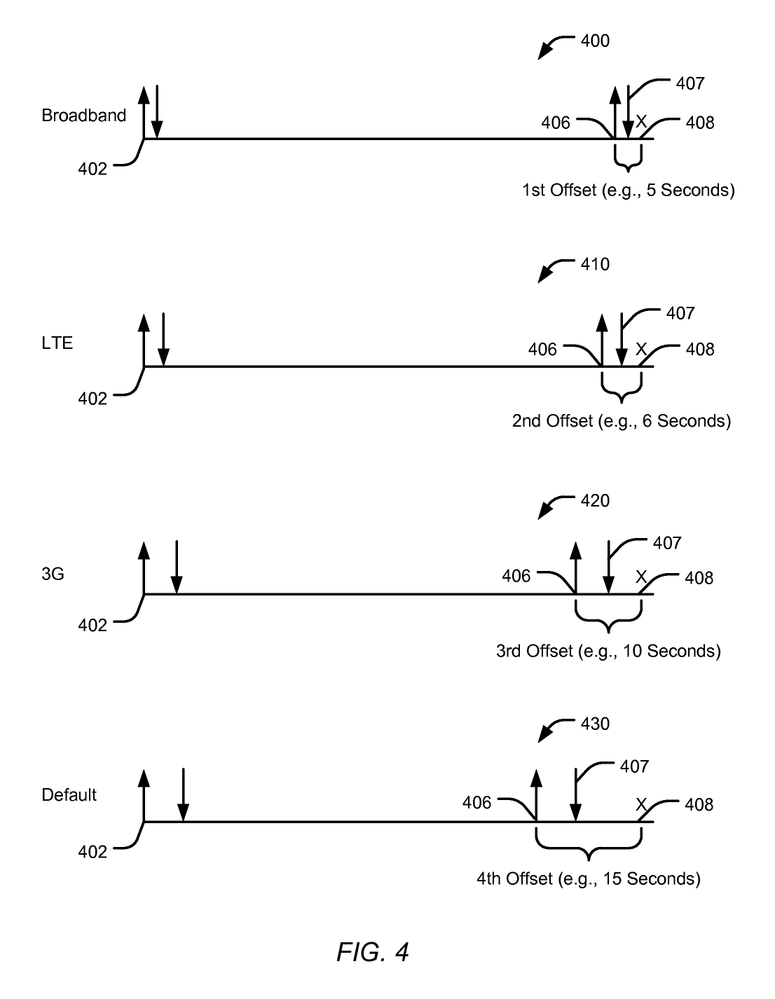

The refresh period determination module 112 may dynamically determine the session refresh period based on the type of the network 130. For example, a longer session refresh period (e.g., 95% or greater of the session expiration period as opposed to less than 95%) may be selected when the network 130 is of a type (e.g., a broadband network, a LTE network, etc.) that is capable of transmitting data at higher speeds than another type of network (e.g., a 3G network, a 2G network, etc.). Also, a shorter session refresh period may be selected when the network 130 is of a type that transmits data at lower speeds than another type of network. Particular methods for selecting the session refresh period based on the type of network are further described with reference to FIG. 3 and FIG. 4.

By dynamically selecting a longer refresh period for a particular type of network that is capable of higher transmission speeds than other types of networks, the client device 110 may reduce the amount of time between when the session refresh message 146 is sent and when the session expires. Extending the session refresh period results in refresh messages being sent less frequently. Hence, dynamically selecting a longer refresh rate results in less traffic over the network 130.

In another embodiment, the refresh period determination module 112 may measure a response time of the network 130. For example, the refresh period determination module 112 may measure a time period from when the message 142 is sent to the server 120 to when an acknowledgment (e.g., the session expiration period 144) corresponding to the message 142 is received. The characteristics used to determine the session refresh period may include the measured response time of the network 130. Based on the measured response time of the network 130, the refresh period determination module 112 may dynamically select a session refresh period. For example, the session refresh period may equal the session expiration period reduced by the response time and further reduced by a safety margin. To illustrate, the refresh period determination module 112 may measure one second from when the message 142 is sent to when the acknowledgment is received. The refresh period determination module 112 may determine a safety margin to be a multiple of three times the measured response time (e.g., three seconds) in order to be able to resend the session refresh message 146 if needed. The refresh period determination module 112 may select the session refresh period to equal the session expiration period reduced by four seconds (including the one second response time and the three seconds safety margin). The client device 110 may transmit a refresh message 146 upon expiration of the selected refresh period.

By measuring the response time of the network 130, the client device 110 may obtain an estimate of the time required to process the session refresh message 146. Using the measured response time, the client device 110 may delay sending the session refresh message 146 until just enough time remains to perform the refresh operation (plus a safety margin). Measuring the response time may provide a more accurate estimate of the required time to process the refresh message 146 than estimating the required time to process the refresh message based on the type of the network 130. The safety margin may be selected to provide sufficient time for the client device 110 to transmit a second session refresh message 146 before expiration of the session. For example, the safety margin may be a multiple (e.g., three times) of time required to process the session refresh message 146 so that if an acknowledgment is not received by the measured response time plus the time required to process the session refresh message 146, the client device 110 may have sufficient time to resend the refresh message 146 before expiration of the session.

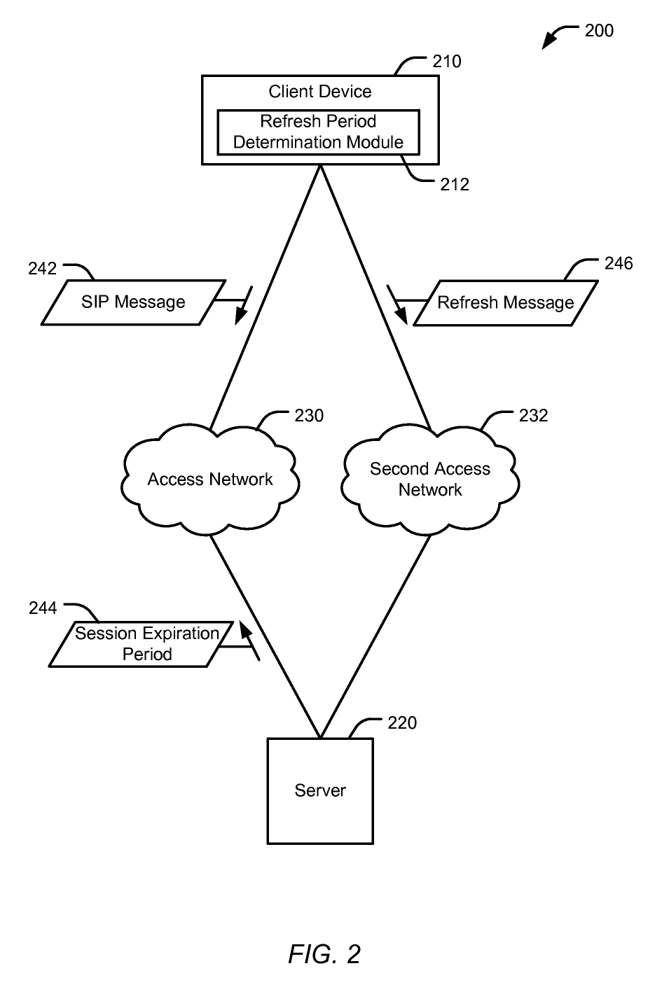

Referring to FIG. 2, a system 200 for dynamically selecting a session refresh interval after a triggering event includes a client device 210 (e.g., a personal computer (PC), a tablet, a set-top box (STB), a personal digital assistant (PDA), a mobile device, a palmtop computer, a laptop computer, a desktop computer, a communications device, a wireless telephone, etc.). The system 200 further includes a server 220 initially coupled to the client device 210 via a network 230. The system 200 may further include a second network 232. The client device 210 may be able to switch between communicating with the server 220 via the network 230 and communicating with the server 220 via the second network 232. The client device 210, the server 220, and/or the network 230 may correspond respectively to the client device 110, the server 120, and/or the network 130 of FIG. 1.

The client device 210 may include a refresh period determination module 212 configured to determine a session refresh period based on characteristics corresponding to a network used by the client device 210 to communicate with the server 220. The refresh period determination module 212 may correspond to the refresh period determination module 112 of FIG. 1. The refresh period determination module 212 may be configured to determine a first session refresh period based on characteristics associated with the network 230 when the client device 210 communicates with the server 220 via the network 230. The refresh period determination module 212 may also be configured to determine a second session refresh period based on characteristics associated with the second network 232 in response to a triggering event (e.g., switching networks so that the client device 210 communicates with the server 220 via the second network 232). Other examples of triggering events include changes to a data path between the client device 210 and the server 230, changes to the topology of the network 230, configuration changes to the network 230, changes to a network device of the network 230, or any combination thereof. In FIG. 2, the second network 232 may represent the network 230 after the network 230 is changed by the one or more triggering events. The first session refresh period may equal the second session refresh period or the first session refresh period may be longer or shorter than the second session refresh period. Although FIG. 2 illustrates two networks, the refresh period determination module 212 may be configured to determine a session refresh period based on characteristics associated with any number of networks that the client device 210 may use to communicate with the server 220.

In operation, the client device 210 may send a message 242 to the server 220 via the network 230. In response to the message 242, the server 220 may send an indication of a session expiration period 244 to the client device 210 via the network 230 or via the second network 232 depending on which particular network the client device 210 uses to communicate with the server 220 at the time the indication of the session expiration period 244 is sent. Alternatively, the server 120 may send the indication of the session expiration period 244 at a time the client device 210 registers on the network (before the message 242 is sent). The refresh period determination module 212 may initially determine a session refresh period based on characteristics associated with the network 230. Upon detection, by the refresh period determination module 212, that the client device 210 is communicating with the server 220 via the second network 232 (e.g., after a triggering event) the refresh period determination module 212 may determine a second refresh period based on a second performance characteristic of the second network 232. For example, a user of the client device 210 may take some action (e.g., moving from one location to another, changing a setting of the client device 210, etc.) that results in the client device 210 switching from being connected to the server 220 via the network 230 to being connected via the second network 232. As another example, a signaling route between the client device 210 and the server 230 may be changed, effectively changing the network 230 into the network 232.

When the client device 210 detects the switch (or another triggering event), the client device 210 may repeat the determination of the session refresh period based on second characteristics associated with the second network 232. The refresh period determination module 212 may determine a second session refresh period based on a type of the second network 232, based on a measured response time of the second network 232, or any combination thereof.

Dynamic selection of a session refresh period after switching networks may enable the client device 210 to select a session refresh period based on characteristics of the second network 232 instead of using the previously determined session refresh period based on characteristics of the network 230. Dynamically selecting a session refresh period after switching networks may decrease network traffic.

Referring to FIG. 3, a first embodiment of a method of dynamically selecting a session refresh interval includes selecting a portion of an expiration period based on a type of network. FIG. 3 includes a first timing chart 300 corresponding to a broadband network, a second timing chart 310 corresponding to a LTE network, a third timing chart 320 corresponding to a 3G network, and a fourth timing chart 330 corresponding to another type of network. Although the particular embodiment of FIG. 3 is described in terms of broadband networks, LTE networks, 3G networks, and other networks, information related to any type of network may be used to dynamically select the session refresh interval.

The timing charts 300-330 show that a message may be sent from a client device (such as the client device 110 of FIG. 1 or the client device 210 of FIG. 2) to a server (such as the server 120 of FIG. 1 or the server 130 of FIG. 2) at a first time 302. A session may be initiated or refreshed in response to the message. The client device may receive an acknowledgment corresponding to the message, at a second time 304. At a third time 306, the client device may send a session refresh message to the server. The session refresh message may be sent before the session expires, which absent the session refresh message, would occur at a fourth time 308. In the timing charts 300-330, the time between the first time 302 when the message is sent and the second time 304 when the acknowledgment is received is illustrated as being shorter for a broadband network (e.g. a Wi-Fi network, or another type of wireless or wired high-speed network) than for an LTE network. This is because the broadband network may have a faster response time than the LTE network. Similarly, the time between the first time 302 and the second time 304 may be shorter for the LTE network than for a 3G network. Also, the time between the first time 302 and the second time 304 may be shorter for the 3G network than other types of networks.

In FIG. 3, a session expiration period may include a time period from the first time 302 when the message is sent from a client device to the fourth time 308 when the session expires. Alternatively, the session expiration period may begin after the first time 302 and before the second time period 304 when the acknowledgment corresponding to the message is received. In a particular embodiment, the session expiration period begins when the message is received by the server. The server may then send an acknowledgment to the client device indicating the session expiration period.

As illustrated in FIG. 3, a client device may determine the session refresh period to be a first portion of a session expiration period when the network is a broadband network, a second portion of the session expiration period when the network is an LTE network, a third portion of the session expiration period when the network is a 3G network, or a fourth portion of the session expiration period when the network is another type of network. The second portion may be smaller than the first portion, the third portion may be smaller than the second portion, and the fourth portion may be smaller than the third portion. For example, the client device may include the refresh period determination module 112 of FIG. 1 or the refresh period determination module 212 of FIG. 2. In a particular embodiment, using the refresh period determination module 112, 212, the client device may determine that the session refresh period is between about 98 and 99 percent of the session expiration period when the network is a broadband network. The client device may determine that the session refresh period is between about 95 and 98 percent of the session expiration period when the network is a LTE network. The client device may determine that the session refresh period is between about 90 and 95 percent of the session expiration period when the network is a 3G network. The client device may determine that the session refresh period is between about 80 and 90 percent of the session expiration period when the network is another type of network (e.g., second generation (2G), digital subscriber line (DSL), etc.). Different percentages may be used depending on relative transmission rates associated with the types of networks. Based on the determined percentages, the client device may select a duration of the session refresh period.

By dynamically selecting a refresh period as a portion of a session expiration period based on a type of network, a client device may avoid sending a refresh message too soon (e.g., long before the session expires). For example, on types of networks that are typically faster than other types of networks, the client device may safely delay sending the refresh message, relying on the faster response time of the network. Sending session refresh messages too soon may increase traffic over the network (including the access network and the core network). Thus, delaying sending refresh messages may reduce traffic over the network, creating a better user experience.

Referring to FIG. 4, a second embodiment of dynamically selecting a session refresh interval includes selecting an offset period based on a type of network (e.g., the network 130 of FIG. 1 or the networks 230, 232 of FIG. 2). FIG. 4 includes a first timing chart 400 corresponding to a broadband network, a second timing chart 410 corresponding to a LTE network, a third timing chart 420 corresponding to a 3G network, and a fourth timing chart 430 corresponding to another type of network. The types of networks used to determine the offset period are not limited to broadband networks, LTE networks, and 3G networks. Information related to any type of network may be used to dynamically select the offset period used to determine the session refresh period.

In the embodiment of FIG. 4, a client device (such as the client device 110 of FIG. 1 or the client device 210 of FIG. 2) determines the refresh period by subtracting an offset period from a session expiration period. The session expiration period may begin at a first time 402 and end at a second time 408. The offset period may be a fixed period of time that corresponds to the time required to perform a refresh operation on a particular type of network plus a safety margin. For example, the offset period may begin at a third time 406 when a refresh message is sent and end at the second time 408 when the session period expires. As shown in FIG. 4, the offset period includes sufficient time for the refresh operation to be completed as indicated by an acknowledgment 407 received by the client device from a server before the session expiration at the second time 408.

The offset period may be selected based on the type of the network. For example, as illustrated in FIG. 4, a client device may determine the session refresh period to be equal to the session expiration period reduced by the offset period. The offset period may be a first offset period when the network is a broadband network, a second offset period when the network is an LTE network, a third offset period when the network is a 3G network, or a fourth offset period when the network is another type of network. The first offset period may be smaller than the second offset period, the second offset period may be smaller than the third offset period, and the third offset period may be smaller than the fourth offset period. For example, the client device may determine that the session refresh period is equal to a session expiration period reduced by between 1 and 5 seconds (e.g., the first offset period) when the network is a broadband network. The client device may determine that the session refresh period is equal to the session expiration period reduced by between 5 and 6 seconds (e.g., the second offset period) when the network is a LTE network. The client device may determine that the session refresh period is equal to the session expiration period reduced by between 6 and 10 seconds (e.g., the third offset period) when the network is a 3G network. The client device may determine that the session refresh period is equal to the session expiration period reduced by between 10 and 15 seconds (e.g., the fourth offset period) when the network is another type of network. Different periods may be used depending on the relative transfer rates associated with the types of networks.

In an embodiment, the offset period may be based on a quality of service (QoS) setting associated with the network. For example, a network that grants priority to refresh messages from the client device may require less time to perform the refresh operation than a network that does not grant priority to refresh messages from the client device. A network that includes QoS settings may use priority queuing to process the refresh messages in a consistent manner, allowing for a period of time that is relatively stable or predictable to be associated with performing the refresh operation. Further, if QoS settings permit priority queuing for refresh messages, a variability of delay (e.g., due to jitter) may be larger than if priority queuing is not enabled. The larger variability of delay may require a larger safety margin, further affecting the duration of the overall offset period. If a QoS setting does not grant priority to refresh messages from the client device or if the network does not have QoS settings, then the amount of time taken to perform the refresh operation may depend on the amount of traffic and congestion on the network. Thus, a longer offset period may be selected to account for variations in the amount of time to process the refresh message. To illustrate, the client device 110 of FIG. 1 may determine a QoS setting associated with the network 230. For example, the client device 110 may query a network device (e.g., a wireless access point, a residential gateway, a network database, etc.) associated with the network 130 to determine whether a QoS setting associated with the network 130 grants priority to refresh messages from the client device. Alternatively, the client device 110 may retain (e.g., in a memory of the client device 110) QoS information associated with the network 130.

In the embodiment of FIG. 4, the offset time between the third time 406 when the refresh message is sent and the second time 408 when the session expires does not depend on the length of the session expiration period. Regardless of the length of the session expiration period, the refresh message may be delayed until only enough time to perform the refresh operation plus a safety margin remains before the session expires. By further delaying sending the refresh message from the client device, traffic over the network may be further reduced.

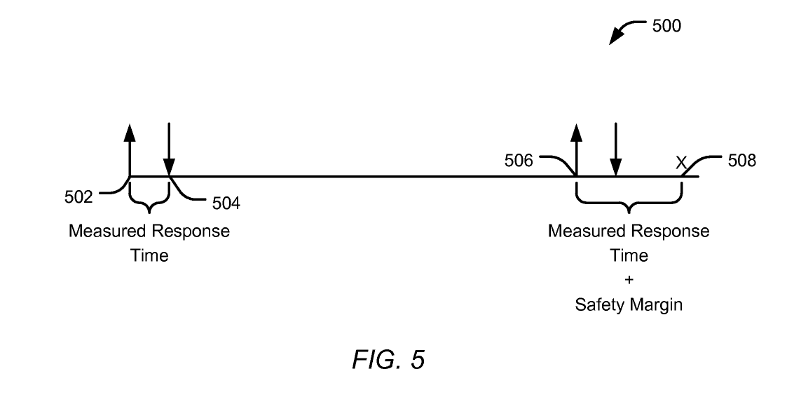

Referring to FIG. 5, a third embodiment of a method of dynamically selecting a session refresh interval includes selecting an offset period based on a measured response time and a safety margin, as illustrated by a timing chart 500. A client device (e.g., the client device 110 of FIG. 1 or the client device 210 of FIG. 2) may measure a response time of a network (e.g., the network 130 of FIG. 1 or the networks 130, 132 of FIG. 2) coupled to the client device. For example, the client device may send a message at a first time 502 and receive an acknowledgment at a second time 504. The client device may measure the amount of time between the first time 502 and the second time 504. The measured amount of time corresponds to a measured response time of the network.

In the embodiment of FIG. 5, a client device may determine the refresh period by subtracting the measured response time from a session expiration period. The session expiration period may begin at a first time 502 and end at a third time 508. The client device may further subtract a safety margin from the session expiration period to determine the session refresh period. Thus, the session refresh period may be equal to the session expiration period reduced by the measured response time of the network, and further reduced by a safety margin time. The safety margin time may be a multiple of the measured response time. For example, the safety margin may be selected to provide sufficient time for the client device to transmit a second session refresh message before expiration of the session. To illustrate, the safety margin may be a multiple of time required to process the session refresh message 146 so that if an acknowledgment is not received by the measured response time plus the time required to process the session refresh message 146, the client device 110 may have sufficient time to resend the refresh message 146 before expiration of the session. In a particular embodiment, the safety margin time is between two and five times the measured response time.

In the embodiment of FIG. 5, the client device may obtain an accurate estimate of the time required to process a session refresh message based on a measured response time of the network. Using the measured response time, the client device may delay sending the refresh message until enough time remains to perform the refresh operation plus a safety margin. Measuring the response time may provide a more accurate estimate of the required time to process the refresh message than estimating the required time to process the refresh message based on a type of the network. Thus, the client device may further delay sending a session refresh message, further reducing unnecessary traffic over the network. Further, determining the session refresh period based on the response time of the network may be performed independently of the type of the network. Thus, the embodiment of FIG. 5 is not limited to any particular types of network.

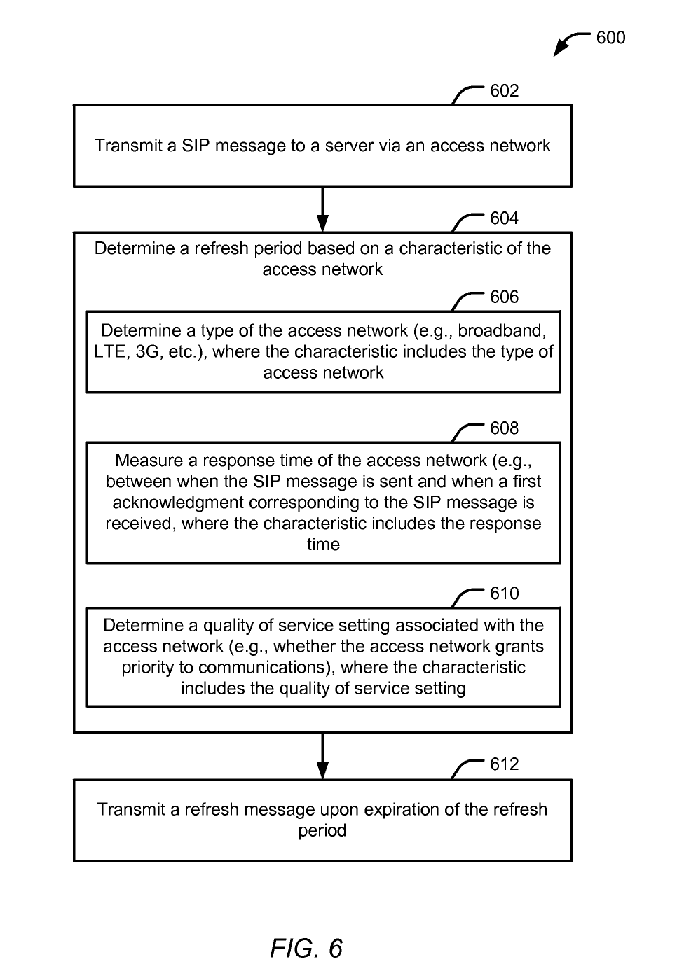

Referring to FIG. 6, a method 600 of dynamically selecting a session refresh interval may include transmitting a message to a server via a network, at 602. For example, referring to FIG. 1, the client device 110 may transmit the message 142 (e.g., a Publish message or a Subscribe message) to the server 120.

The method 600 may further include determining a characteristic associated with the network, at 604. For example, the client device 110 may determine the session refresh period based on characteristics, such as a response time, of the network 130 that are indicative of the amount of time required to perform a refresh operation.

Determining the characteristics of the network may include determining a type of the network, at 606. For example, the network may be a broadband network, a LTE network, a 3G network, or another type of network. The type of the network may indicate or may be correlated with a response time of the network. For example, a broadband network may transfer data faster than an LTE network. The LTE network may transfer data faster than a 3G network, and the 3G network may transfer data faster than other types of networks.

Determining the characteristics of the network may include measuring a response time of the network, at 608. For example, a client device may measure a time period between when the message is sent and when a first acknowledgment corresponding to the message is received at the client device, as described with reference to FIG. 5.

Determining the characteristics of the network may include determining a quality of service (QoS) setting associated with the network, at 610. For example, a client device may determine whether the network grants priority to communications (e.g., session refresh messages) from the client device.

The method 600 may include determining a session refresh period based on the determined characteristics of the network, at 612. For example, when a characteristic of the network includes a type of the network, determining the session refresh period based on the type of the network may be performed as described with reference to FIG. 3 or with reference to FIG. 4. The session refresh period may equal a portion of a session expiration period (e.g., from the time 302 to the time 306 of FIG. 3) or the session refresh period may equal the session expiration period reduced by an offset period (e.g., from the time 406 to the time 408 of FIG. 4). When a characteristic of the network includes a measured response time of the network, the session refresh period may equal the measured response time plus an additional safety margin (e.g., from the time 506 to the time 508 of FIG. 5). When a characteristic of the network includes a QoS setting associated with the network, the offset period as described with reference to FIG. 4 and/or the safety margin as described with reference to FIG. 5, may be longer or shorter, depending on the quality of service setting.

In an embodiment, the session refresh period may be determined based on a combination of the type of the network, the measured response time of the network, and the quality of service setting of the network. For example, the client device may select a first session refresh period based on the network type and a second session refresh period based on the measured response time. The longer of the first and second session refresh periods may be selected to reduce traffic over the network. Alternatively, the shorter of the first and second session refresh periods may be selected to permit sufficient time for the session refresh operation to be completed. The quality of service setting may be used in combination with the network type and/or the measured response time to determine the session refresh period. For example, when the network grants priority to refresh messages from the client device, a first safety margin may be used to determine the offset period or the amount of time to add to the measured response time to calculate the session refresh period. When the network does not grant priority to refresh messages from the client device or when the network does not have a quality of service setting, a second safety margin that is longer than the first safety margin may be used.

The method 600 may also include transmitting a session refresh message upon expiration of the session refresh period, at 614. For example, the client device 110 of FIG. 1 may transmit the session refresh message 146 to the server 120 upon expiration of the session refresh period determined by the refresh period determination module 112. In an embodiment, the session refresh message is a copy of the message. Alternatively, the session refresh message may be a truncated version of the message.

By dynamically selecting a longer session refresh period for a network that is capable of higher transmission speeds (determined based on a type of the network, a measured response time of the network, or a QoS setting of the network) than other networks, the client device may avoid sending a refresh message long before the session expires. For example, for types of networks that are typically faster than other types of networks, the client device may safely delay sending the refresh message, relying on the faster response time of the network. Thus, overall traffic over the network may be reduced, creating a better user experience.

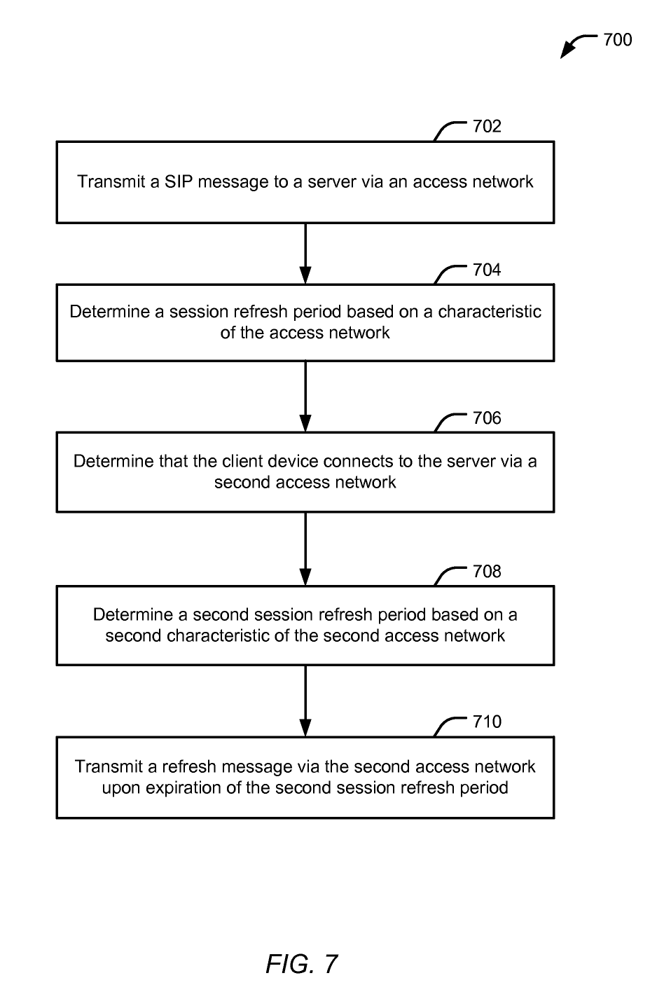

Referring to FIG. 7, a method 700 of dynamically selecting a session refresh interval after switching networks may include receiving an indication of a session expiration period from a server via a network, at 702. For example, the client device 210 of FIG. 2 may receive the session expiration period 244 from the server 220 via the network 230. The method 700 may include determining a characteristic associated with the network, at 704. The method 700 may further include determining a session refresh period based on the determined characteristic of the network, at 706. The method 700 may also include determining that the client device connects to the server via a second network, at 708. For example, the client device 210 may switch between communicating with the server 220 via the network 230 and the second network 232 (e.g., as a result of movement of the client device 210).

The method 700 may include determining a second refresh period based on a second characteristic of the second network, at 710. For example, the client device 210 of FIG. 2 may switch from communicating via the network 230 (e.g., a broadband network) to communicating via the second network 232 (e.g., a LTE network). The network 230 may have a faster data transfer rate than the second network 232. Therefore, the duration of the session refresh period may be determined to be longer than the duration of the second session refresh period.

The method 700 may further include transmitting a refresh message via the second network upon expiration of the second refresh period, at 712. For example, the client device 210 may send the session refresh message 246 via the second network 232 instead of via the initial network 230. The client device 210 may refrain from sending the session refresh message 246 via the initial network 230 after having detected a switch from communicating with the server 230 via the initial network 230 to communicating with the server 230 via the second network 232.

Dynamic selection of a session refresh period after switching networks may enable the client device 210 to select a session refresh period based on characteristics of the second network 232 instead of using the previously determined session refresh period based on characteristics of the first network 230. Dynamically selecting a session refresh period after switching networks may decrease network traffic.

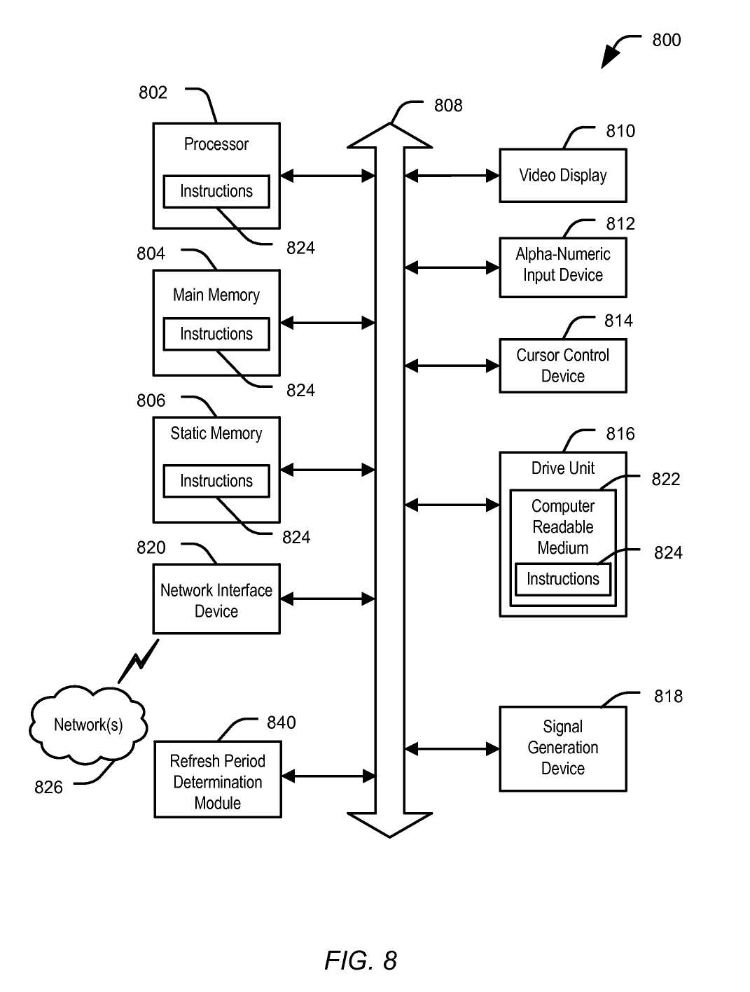

FIG. 8 is a block diagram illustrating an embodiment of a general computer system that is generally designated 800. The computer system 800 may be operable to support embodiments of computer-implemented methods, computer program products, and system components as illustrated in FIGS. 1-7. For example, the computer system 800, or components thereof, may be incorporated into the client device 110 of FIG. 1, the server 120 of FIG. 1, a network device of the network 130 of FIG. 1, the client device 210 of FIG. 2, the server 220 of FIG. 2, or a network device of one or both of the networks 230, 232 of FIG. 2. As another example, the computer system 800 may be configured to determine the first portion, the second portion, the third portion, and the fourth portion of FIG. 3. The computer system 800 may also be configured to determine the first offset, the second offset, the third offset, and the fourth offset of FIG. 4. The computer system 800 may also be configured to determine the measured response time and safety margin of FIG. 5. The computer system 800 may also be configured to dynamically determine a refresh period based on a characteristic of the network, as in FIGS. 6 and 7. The computer system 800, or any portion thereof, may operate as a standalone device or may be coupled, e.g., using a network, to other computer systems or peripheral devices.

The computer system 800 may be incorporated into the client device 110 of FIG. 1, the server 120, a network device of the network 130, the client device 210 of FIG. 2, the server 220, or a network device of one or both of the networks 230, 232. The client device 110 of FIG. 1, the server 120, the network device of the network 130, the client device 210 of FIG. 2, the server 220, or the network device of one or both of the networks 230, 232 may be controlled by a controller 828 of the computer system 800.

The computer system 800 can also be implemented as or incorporated into various devices, such as a tablet, a personal digital assistant (PDA), a palmtop computer, a laptop computer, a communications device, a web appliance, a display device, a computing device, or any other machine capable of executing a set of instructions (sequential or otherwise) that specify actions to be taken by that machine. Further, while a single computer system 800 is illustrated, the term “system” shall also be taken to include any collection of systems or sub-systems that individually or jointly execute a set, or multiple sets, of instructions to perform one or more computer functions.

As illustrated in FIG. 8, the computer system 800 may include a processor 802, e.g., a central processing unit (CPU). In a particular embodiment, the processor 802 may include multiple processors. For example, the processor 802 may include distributed processors, parallel processors, or both. The multiple processors may be included in, or coupled to, a single device or multiple devices. The processor 802 may be used to support a virtual processing environment. In a particular embodiment, the processor 802 may include a state machine, an application specific integrated circuit (ASIC), or a programmable gate array (PGA) (e.g., a field programmable gate array (FPGA)).

Moreover, the computer system 800 may include a main memory 804 and a static memory 806 that may communicate with each other via a bus 808. In a particular embodiment, the main memory 804 may include processor-executable instructions 824. As shown, the computer system 800 may further include or be coupled to a display unit 810, such as a liquid crystal display (LCD), an organic light emitting diode (OLED), a flat panel display, a solid-state display, or a projection display. Additionally, the computer system 800 may include an input device 812, such as a keyboard, a remote control device, and a cursor control device 814, such as a mouse. In a particular embodiment, the cursor control device 814 may be incorporated into the remote control device. The computer system 800 may also include a disk drive unit 816, a signal generation device 818, such as a speaker, and a network interface device 820. The network interface device 820 may be coupled to other devices (not shown) via a network 826.

In a particular embodiment, one or more of the components of the computer system 800 may be coupled to a refresh period determination module 840. The refresh period determination module 840 may correspond to the refresh period determination module 112 of FIG. 1, the refresh period determination module 212 of FIG. 2, or both. The refresh period determination module 840 may be configured to determine a session refresh period based on a type of a network, based on a measured response time of the network, and/or based on a quality of service setting associated with the network. The refresh period determination module 840 may be partially or entirely implemented as circuitry within the computing device 800. Alternatively, the refresh period determination module 840 may be partially or entirely implemented as particular instructions included in the instructions 824.

In a particular embodiment, as depicted in FIG. 8, the disk drive unit 816 may include a tangible computer-readable storage device 822 in which one or more sets of instructions 824, e.g. software, may be embedded. Further, the instructions 824 may embody one or more of the methods or logic as described herein. The processor 802 may execute the instructions 824 to perform operations corresponding to one or more of the methods or logic as described herein. The processor 802 may perform the operations directly, or the processor 802 may facilitate, direct, or cooperate with another device or component to perform the operations.

In a particular embodiment, the instructions 824 may reside completely, or at least partially, within the main memory 804, the static memory 806, and/or within the processor 802 during execution by the computer system 800. The main memory 804 and the processor 802 also may include computer-readable memory.

In an alternative embodiment, dedicated hardware implementations, such as application specific integrated circuits, programmable logic arrays and other hardware devices, can be constructed to implement one or more of the methods described herein. One or more embodiments described herein may implement functions using two or more specific interconnected hardware modules or devices with related control, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limiting embodiment, implementations can include distributed processing and parallel processing. Alternatively, virtual computer system processing can be used to implement one or more of the methods or functionality as described herein.

A computer-readable storage device 822 stores the instructions 824 and a processor (e.g., the processor 802) executes the instructions 824, so that the refresh period determination module 840 may determine a session refresh period. For example, the computer-readable storage device 822 device may include or be included within one or more of the components of the client device 110 of FIG. 1, the server 120, a network device of the network 130, the client device 210 of FIG. 2, the server 220, or a network device of one or both of the networks 230, 232. While the computer-readable storage device 822 is shown to be a single device, the computer-readable storage device 822 may include multiple devices. The computer-readable storage device 822 is capable of storing a set of instructions for execution by a processor to cause a computer system to perform any one or more of the methods or operations disclosed herein.

In a particular non-limiting, exemplary embodiment, the computer-readable storage device 822 may include a solid-state memory such as a memory card or other package that houses one or more non-volatile read-only memories. Further, the computer-readable storage device 822 may be a random access memory or other volatile re-writable memory. Additionally, the computer-readable storage device 822 may include a magneto-optical or optical device, such as a disk, tapes, or other storage device.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. As the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method comprising:
transmitting, from a client device, a message to a server via a network;
determining a characteristic associated with the network;
determining, at the client device, a session refresh period, wherein a duration of the session refresh period is determined based on the determined characteristic associated with the network; and
transmitting, from the client device, a refresh message to the server upon expiration of the session refresh period.

2. The method of claim 1, further comprising determining a type of the network, wherein the characteristic includes the type of the network.

3. The method of claim 2, wherein determining the type of the network comprises determining whether the network is a broadband network, a long term evolution network, a third generation network, or another type of network.

4. The method of claim 1, wherein the session refresh period is determined to be a first portion of a session expiration period when the network is a broadband network, a second portion of the session expiration period when the network is a long term evolution network, a third portion of the session expiration period when the network is a third generation network, and a fourth portion of the session expiration period when the network is another type of network, wherein the second portion is less than the first portion, wherein the third portion is less than the second portion, and wherein the fourth portion is less than the third portion.

5. The method of claim 4, wherein the first portion includes between 98 percent and 99 percent of the session expiration period, wherein the second portion includes between 95 percent and 98 percent of the session expiration period, wherein the third portion includes between 90 percent and 95 percent of the session expiration period, and wherein the fourth portion includes between 80 percent and 90 percent of the expiration period.

6. The method of claim 1, wherein the session refresh period is determined to be a session expiration period reduced by an offset period, and wherein the offset period is determined based on the characteristic.

7. The method of claim 1, wherein the session refresh period is determine to be a session expiration period reduced by:
a first offset period when the network is a broadband network;
a second offset period when the network is a long term evolution network;
a third offset period when the network is a third generation network; and
a fourth offset period when the network is another type of network,
wherein the second offset period is longer than the first offset period, wherein the third offset period is longer than the second offset period, and wherein the fourth offset period is longer than the third offset period.

8. The method of claim 7, wherein the first offset period is between one second and five seconds, wherein the second offset period is between five seconds and six seconds, wherein the third offset period is between six seconds and ten seconds, and wherein the fourth offset period is between ten seconds and 15 seconds.

9. The method of claim 1, further comprising measuring a response time of the network, wherein the characteristic includes the measured response time.

10. The method of claim 9, wherein measuring the response time of the network comprises measuring a time period from a first time when the session initiation protocol message is sent to a second time when a first acknowledgment corresponding to the session initiation protocol message is received.

11. The method of claim 1, wherein the session refresh period is determined to be a session expiration period reduced by a measured response time of the network and further reduced by a safety margin time.

12. The method of claim 11, wherein the safety margin time is two to five times the measured response time.

13. The method of claim 1, further comprising determining a quality of service setting associated with the network, wherein the characteristic includes the quality of service setting.

14. The method of claim 13, wherein determining the quality of service setting associated with the network comprises determining whether the network grants priority to communications associated with the client device.

15. The method of claim 1, wherein the session refresh period is determined to have a first length when the network grants priority to communications associated with the client device, wherein the session refresh period is determined to have a second length when the network does not grant priority to the communications associated with the client device, and wherein the first length is greater than the second length.

16. An apparatus comprising:
a processor; and
a memory storing instructions that, when executed by the processor, cause the processor to perform operations comprising:
receiving an indication of a session expiration period from a server via a network;
determining a session refresh period based on a characteristic of the network and based on the session expiration period; and
transmitting a refresh message to the server upon expiration of the session refresh period.

17. The apparatus of claim 16, wherein the operations further comprise:
after determining the session refresh period, detecting a connection to the server via a second network;
determining a second session refresh period based on a second characteristic of the second network, wherein a duration of the session refresh period is different than a duration of the second session refresh period; and
refraining from transmitting the refresh message upon expiration of the session refresh period and transmitting the refresh message upon expiration of the second session refresh period.

18. A computer-readable storage device that stores instructions that, when executed by a processor, cause the processor to perform operations comprising:
initiating transmission of a message from a client device to a server via a network;
receiving an indication of a session expiration period from the server;
determining a session refresh period based on a characteristic of the network and based on the session expiration period; and
initiating transmission of a refresh message from the client device to the server upon expiration of the session refresh period.

19. The computer-readable storage device of claim 18, wherein the message comprises a session initiation protocol message, wherein the session initiation protocol message comprises a publish message, a subscribe message, or a combination thereof, and wherein the refresh message comprises a copy of the session initiation protocol message.

20. The computer-readable storage device of claim 18, wherein the message comprises a hypertext transfer protocol message.
